(19) United States
(12) Patent Application Publication
(10) Pub. No.: US 2004/0024622 A1
(43) Pub. Date: Feb. 5, 2004

(54) Method and system for automating business processes

(75) Inventor: Erik A. Knight, The Colony, TX (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/201,830

(22) Filed: Jul. 23, 2002

(51) Int. Cl. G06F 17/60

(52) U.S. Cl. 705/7

(57) ABSTRACT

A method and system for automating business processes include the ability to determine an appropriate function in a business process, generate a command to execute the function, and receive a message indicating that the function is complete. The method and system also include the ability to determine another appropriate function in the business process and generate a command to execute the second function.

### TECHNICAL FIELD OF THE INVENTION

The present invention relates in general to electronic commerce, and in particular, to a method and system for automating business processes.

### BACKGROUND OF THE INVENTION

Large global enterprises have thousands of processes that are performed regularly in numerous different locations. The processes may involve the management of people, money, and/or technology and may be critical to a an enterprise's operations. Unfortunately, the processes may be implemented differently depending on divisions of the enterprise and may require the intervention by employees who have varying levels of experience and skill. Accordingly, the processes may not be implemented consistently across the enterprise and may not be automated to a significant extent, resulting in inconsistent results when the processes must be used repeatedly and slow reaction times to problems and changing conditions. Additionally, disparate processes that require a high level of human intervention do not lend themselves to being centrally managed, which leads to less than optimal performance of the processes, and any related processes.

### SUMMARY OF THE INVENTION

In accordance with the present invention, a method and system for automating business processes is provided, whereby an enterprise's business processes can be identified, automated, and presented via a common interface. For one example embodiment of the present invention, a method and system for automating an enterprise's business processes includes a process maturity model that identifies the business processes and the tools that they use, and an enterprise application integration layer. The example method and system can also include such features as Web access, enterprise security, and operating system independence.

In particular embodiments, a system for automating business processes includes a plurality of business applications, a middleware layer, and a business process manager. The business applications implement business functions, and the middleware layer is coupled to the business applications and facilitates the passage of data between the business applications. The business process manager is coupled to the middleware layer and is operable to implement a business process that uses at least two of the business applications.

In certain embodiments, a method for automating business processes includes determining an appropriate function in a business process, generating a command to execute the function, and receiving a message indicating that the function is complete. The method also includes determining another appropriate function in the business process and generating a command to execute the second function.

In specific embodiments, a method for automating business processes includes defining a business process to be automated, increasing repeatability of the defined process, and increasing predictability of the defined process. The method also includes automating the business process and refining the business process.

The present invention has a variety of technical features. For example, in certain embodiments, a method and system for automating an enterprise's business processes is provided that can be used to digitalize the business processes involved. This may allow more efficient utilization of the business processes, especially if the processes are identified, coupled to other relevant processes, and accessible via a single tool. As another example, in some embodiments, a method and system for automating an enterprise's business processes is provided that allows the business processes to be executed from any location with consistent results. As an additional example, in particular embodiments, a method and system for automating an enterprise's business processes is provided that can reduce costs and increase efficiency for the enterprise involved. As a further example, in specific embodiments, a method and system for automating an enterprise's business processes is provided that can make these processes available through a single tool. This may allow a business to build and manage a single technology infrastructure to support multiple complex business requirements in a rapidly changing environment.

Of course, certain embodiments, may possess none, one, some, or all of these technical features. Other technical features of the present invention will be readily apparent to one skilled in the art from the following figures, description, and claims.

### BRIEF DESCRIPTION OF THE DRAWINGS

The figures described below provide a more complete understanding of the invention, especially when considered in light of the following detailed description, and of its technical features:

FIG. 1 illustrates a system for automating business processes in accordance with one embodiment of the present invention;

FIG. 2 is a flowchart illustrating a method for designing and managing business processes in accordance with one embodiment of the present invention;

FIG. 3 is a flowchart illustrating a method for implementing business processes in accordance with one embodiment of the present invention;

FIG. 4 illustrates a user interface unit in accordance with one embodiment of the present invention; and

FIG. 5 illustrates a user interface in accordance with one embodiment of the present invention.

### DETAILED DESCRIPTION OF THE INVENTION

FIG. 1 illustrates a system 10 for automating business processes in accordance with one embodiment of the present invention. As illustrated, system 10 includes a user interface unit 20, a communication network 30, a server 40, a business process manager 50, middleware layers 60, and business applications 70.

In general, system 10 allows a digital workplace to be created. For example, an enterprise's business processes can be automated and presented via a common interface. As a result, the enterprise can have one or more of the following features: repeatable business processes; automated business processes; remote access for business processes; utilization of business processes across enterprise lines; metrics for evaluating the effects of business processes; and utilization of change controls to match business processes to changing business requirements. In certain embodiments, a method and system for automating business processes are provided that include such features as Web access, enterprise security, and operating system independence.

In more detail, user interface unit 20 is operable to receive information regarding a business process and present the information to a user and to receive and send information regarding a business from a user. For example, user interface unit 20 may receive a request from a user to determine the status of a business process, send the request to server 40, receive a message regarding the status of the business process, and present information regarding the status to the user. User interface unit 20 may be a personal computer, a laptop computer, a workstation, a personal digital assistant, a cellular telephone, or any other type of device that can receive information and present it to a user.

In particular embodiments, user interface unit 20 may be a personal computer configured with suitable software as an NT Thin Client workstation. Notably, a thin client device is typically a low-cost computing device that can operate in a server-centric computing model. Thus, a typical thin client device does not require a state-of-the-art, powerful processor or large amounts of RAM or ROM, because it can access applications from a central server or network. Thin-client/server computing is a server-based approach for delivering critical applications to end-user devices, whereby an application's logic can be executed on a server and the user interface is conveyed across a network to a client.

Communication network 30 couples user interface unit 20 to server 40. Communication network 30 may be composed of any number and/or type of switches, routers, bridges, repeaters, transmitters, receivers, transceivers, and/or other devices for sending and/or receiving information. The devices may send and/or receive information in analog or digital formats, which may include frame relay, asynchronous transfer mode, X.25, Internet protocol, or any other appropriate protocol. The devices of communication network 30 may be coupled using wires, fiber-optic cables, wireless channels, and/or any other appropriate type of coupling for transferring information. Communication network 30 is coupled to computer 20 and server 40 by links 32. Links 32 may themselves be wires, fiber-optic cables, wireless channels, and/or any other appropriate type of coupling for transferring information. In particular embodiments, communication network 30 is the Internet.

Server 40 may be an enterprise portal, an Internet portal, or any other type of device that allows a device such as user interface unit 20 to access information in an enterprise. As such, server 30 may convey information across communication network 30, using, for example, the HyperText Transfer Protocol (HTTP), to user interface unit 20, which could display it using a Web browser. Server 40 may be used for presentation of information, storing user profiles, personalization of information, content management, publishing, searching, collaboration, application delivery, security, and/or wireless delivery. Through server 40, information may be searched for, organized, and presented to any suitable remote device. In particular embodiments, server 40 may also allow access to services and/or applications in the enterprise. In certain embodiments, server 40 may search for the personnel to which a function of a business process was assigned.

Server 40 may provide a common interface for business applications and middleware layers involved in business processes. For example, a web-based interface can be used as a common interface between user interface unit 20 and business process manager 50 and/or middleware layers 60. As such, a user can view processes and their respective data via a suitable web-browser interface. Typically, an enterprise portal can be used as a common web interface. Such a web interface can be associated with and running on a workstation or other suitable processor, and can also be running on a suitable wireless device (e.g., cellular device, radiotelephone, device operating with the Wireless Application Protocol, etc.).

Server 40 may be used to composite information for internal and/or external users to view and manage business processes. For example, an enterprise's business partner may be invited to use one or more of the enterprise's applications via communication network 30, for such uses as checking the enterprise's inventory, ordering parts from the enterprise, and locating components at the enterprise's premises. Advantageously, having the enterprise's business processes accessible and viewable for business partners makes the processes more understandable, usable, and powerful. As such, a composite application can provide an entrance point to a business process in the intranet of the enterprise. In certain embodiments, the composite application provides a user-specific, web-enabled view of different business processes, which can be designed so as to provide tools and capabilities necessary for a user to accomplish a task, and monitor, measure, and manage the process involved.

Essentially, in accordance with one example embodiment of the present invention, a composite application may provide a visual interface for a business process involved (e.g., a gateway into an enterprise), a middleware layer and workflow tools can provide an application interface to a plurality of an enterprise's business applications, and an enterprise portal can be used to manage the interaction between a user and the infrastructure services involved (e.g., network, security, data repositories, Web tools, etc.).

In particular embodiments, server 40 provides a common entry point for the business processes (to be discussed later) and adds additional tools by allowing the processes to be, analyzed. For example, the server may gather information about a business process from various components of the enterprise, such as purchasing, manufacturing, marketing, human resources, and accounting, and report them in a user customizable interface.

Business process manager 50 may be a server, a computer, a workstation, or any other type of device that can store and process information. In particular embodiments, business process manager 50 may be part of server 40. As illustrated, business process manager 50 includes business process logic 52. Business process logic 52 may be part of a database, stored in a portion of memory, or be part of any other device for storing information. Business process logic 52 contains functions for the defined business processes, and their associated workflow. For example, business process logic 52 may contain a list all of the business processes that are performed through server 40 and what each business application 70 that is involved in a business process requires for input and output. In particular embodiments, business process manager 50 may facilitate the passage of data from one business application to another. Additionally, business process logic 52 may contain metrics for the business processes. The metrics for the business processes, which could be built into business process manager 50 or middleware layers 60 in certain embodiments, may provide a “real-time” view of how each process is progressing. This allows problems to be identified, resources to be allocated, and success to be measured.

To accomplish its functions, business process manager 50 may include a plurality of applet servers that provide business logic for data being searched, organized, and/or presented via server 40. For this embodiment, an applet can be a program that is executed from within an application. As such, a web browser can interpret applets from server 40 and/or an applet server. In particular embodiments, the applets are JAVA applets.

Middleware layers 60 are coupled to business process manager 50 in the example embodiment. Middleware layers 60 include logic 62 for coupling together business applications 70 and passing and/or sharing data between them. For this embodiment, middleware layer 60a may be used to couple together and pass data between business applications 70aa-az, which could include a warehouse application, a procurement application, and a purchasing application. Middleware layer 60z, in turn, may be used to couple together and pass data between business applications 70za-zz, which could include a personnel application, a payroll application, and an accounting application. Accordingly, each of middleware layers 60 may only be used for a portion of an enterprise's functions. Also, middleware layers 60 may provide format translations between their associated applications 70. Thus, middleware layers 60 may provide actual input from one application to another. In particular embodiments, middleware layers 60 perform their functions by using Extensible Markup Language (XML).

In certain embodiments, middleware layers 60 may include tools with metrics that can provide a real-time view of the progress of each function being performed. As a result, process problems can be identified, resources can be allocated, and the success of any process being performed can be readily measured and evaluated.

In order for a system's software tools to be capable of adapting to changing business requirements, it may be necessary for the system to be able to convey data from one application to another. This process is dynamic and requires the applications to communicate with each other. In the present embodiment, middleware layers 60 can facilitate such communication between applications 70. Notably, this exchange of information between applications may be more than just an aggregated view, and can also include an actual input from one program to another. A custom-made applet may be used to format or manipulate the data in accordance with management viewing requirements. However, the result can provide more than just a new view; it can be an application formed from multiple data sources. As such, such an application formed from multiple data sources can be referred to as a composite application.

As indicated previously, business applications 70 perform various functions in the enterprise. In general, there are three types of software applications that are used in a business environment: (1) business support applications, which are similar to office automation tools, desktop tools, and productivity tools; (2) service delivery applications that may manage core business functions, such as enterprise resource planning applications like SAP, BaaN, and Oracle, which may actually control the business resources; and (3) middleware applications, which connect the first two by one or more middleware layers such as middleware layers 60. The middleware layers, which may include workflow applications, can interface with each software business application without the need for a client version in a user's desktop. The use of the middleware layers enables gathering of data from multiple applications, aggregation of the data, and acting on the data relatively quickly as it is made available.

As described, a business process can be considered a series of software interactions that use various tools to manipulate core business functions. If an enterprise desires to move materiel, money, or people, these functions can be performed using a software tool. The inputs and outputs of these tools can be tied together to describe the entire process involved. Furthermore, a server may be used to view, measure, and manage these processes by providing a layer that can function as a common entry point for all processes involved. Also, a server may provide another set of tools that can complement those of the individual software applications. The data used by the server can be in the XML format, which enables the server to communicate with other applications within or outside the enterprise. The use of a server thus may provide a common thread for all of the business processes involved.

For this example embodiment, pertinent business functions can be automated by implementing them as software applications. As such, a number of suitable software applications can be provided for automating an enterprise's business functions by software vendors such as, for example, SAP, BaaN, Siebel, People Soft, Computer Associates, Ramco Systems, and Oracle. Alternatively, proprietary software may be developed for automating a business function if no vendor software is available for implementing that function.

In accordance with the present invention, a method and system for automating business processes may include at least two primary components. A primary function of one such component is to create and manage the business processes involved. For one example embodiment, a process maturity model, discussed below, may be used for designing and managing the business processes involved. A primary function of the other component is to provide a common interface between all of the software applications being used and a user. For example, an enterprise portal can be used to provide a common web interface between the software applications being used and a user. In other words, the business processes and their associated data may be viewed via a web browser interface (e.g., including use of a wireless communication device). In particular embodiments, server 40 accomplishes this by using a composite application, which means that the presentation of data for a business process is not tied to any one business application 70. This allows a business process to appear as a single menu item to a user.

Although system 10 has been discussed with respect to internal business processes-those executed in one enterprise-system 10 could also be used to implement external business processes-those executed across a more than one enterprise. Such processes may begin in one enterprise and require action in a different enterprise and could be described as having process threads that execute in different environments, the external process threads being dependent on the tools that the other enterprise has in place. In accomplishing this, system 10 may track a process in different enterprises using inputs from reporting tools that exist in the different enterprises. For example, business partners can be allowed to check inventory, order parts, locate components, or any other appropriate business related function. For one example embodiment, suitable workflow integration tools and process integration tools using XML can be used to link business processes across the different tools being used.

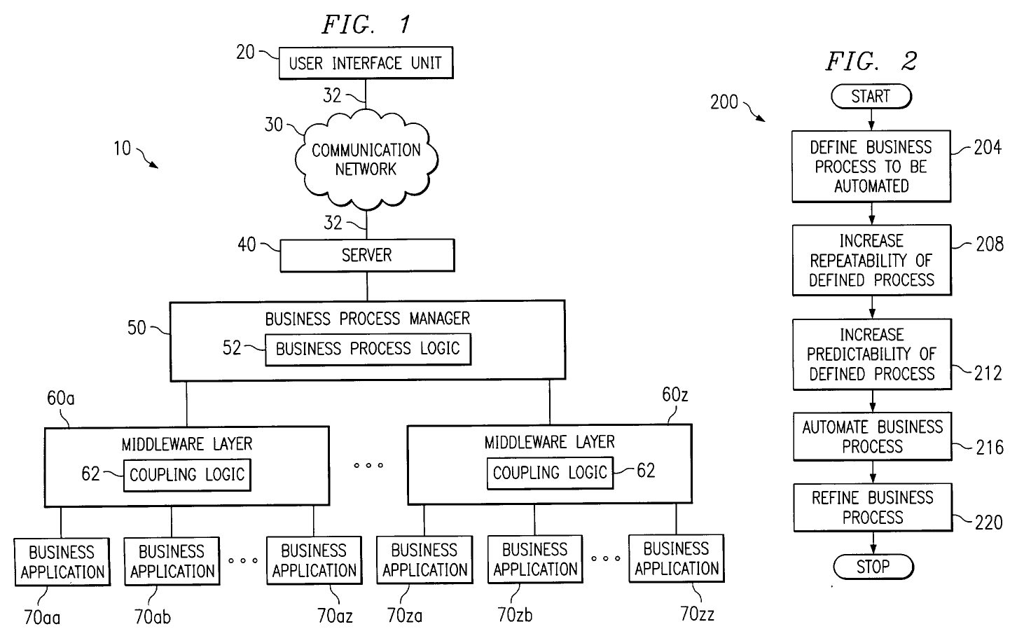

FIG. 2 is a flowchart 200 illustrating a method for designing and managing business processes in accordance with one embodiment of the present invention. As illustrated, flowchart 200 is a process maturity model, identifying levels of business process development.

The method begins at function block 204 with defining a business process to be automated. Such processes are typically those that will be repeated numerous times and that can be automated. For example, when a new employee joins an enterprise, numerous functions may have to be performed, such as formalizing employment in human resources, registration with security, assignment of an office, establishment of a computer account, initiation of phone service, registration with payroll, and enrollment in health insurance plans. One or more of these functions may be performed by disparate departments, software programs, and/or people within the enterprise. Thus, identifying the functions that need to be performed, what and/or who will perform them, and a logical order for their progression will typically lead to definition of a business process. The business process may also be documented, and lines of responsibility and authority may be established, which will increase accountability. A business process may be defined by the use of peer groups, quality workgroups, training programs, intergroup coordination, integrated software, and engineering of integrated processes.

At function block 208, the repeatability of the defined business is increased, if possible, in order to produce consistent results. For example, the business process may be made repeatable by such techniques as suitable project tracking and management, subcontract management, quality assurance, configuration management, change control management, requirements management, creation of documentation, training, uncoupling processes from individual performers, and/or reorganizing structure.

At function block 212, the predictability of the defined process is increased. For example, predictability may be increased by developing suitable metrics so that the results of the defined business process may be measured, which will help to ensure predictable results. Using metrics, problems can be identified, resources can be allocated, and success can be measured. For instance, metrics may be utilized to obtain quantitative feedback for improving the business processes involved. An example of a metric is the time taken to achieve a function. In general, process engineering on an enterprise level may be used to address the predictability of the business process. The business process may be analyzed from the enterprise level with peer reviews, quality workgroups, training programs, intergroup coordination, integrated software, and/or engineering of integrated processes.

At function block 216, the method calls for automating the business process. This may include implementing business service logic 52 to coordinate activities between middleware layers 60 and/or business applications 70, obtaining a program 70 to implement a function, and/or associating a group of persons with a function. In certain embodiments, the pertinent business processes can be automated by implementing them as software applications. Note that this function allows a business process to be available for an entire enterprise.

At function block 220, the business process may be refined by monitoring it and, if necessary, making process driven changes to the business process. For example, the metrics may be used to provide quantitative feedback regarding the process and, hence, suggest improvements. If problems occur, and/or if improvements are necessary to a business process, change control workflows may be generated, meetings may be set, and/or reports may be generated. Additionally, innovative technologies may be identified, evaluated, and incorporated to manage the process. Changes to a business process are preferably associated with that business process and not with a requirement imposed that is derived external to that process.

Method 200 has several technical features. For example, by using the model, the risk and inconsistency of disjoined, non-automated processes may be turned into productivity and quality. Moreover, by disassociating an individual from the business process, reliability is increased as single points of failure are reduced. Additionally, method 200 creates repeatable business processes, automates processes with software, provides metrics to evaluate the effects of processes, and uses change control to match processes to changing business requirements.

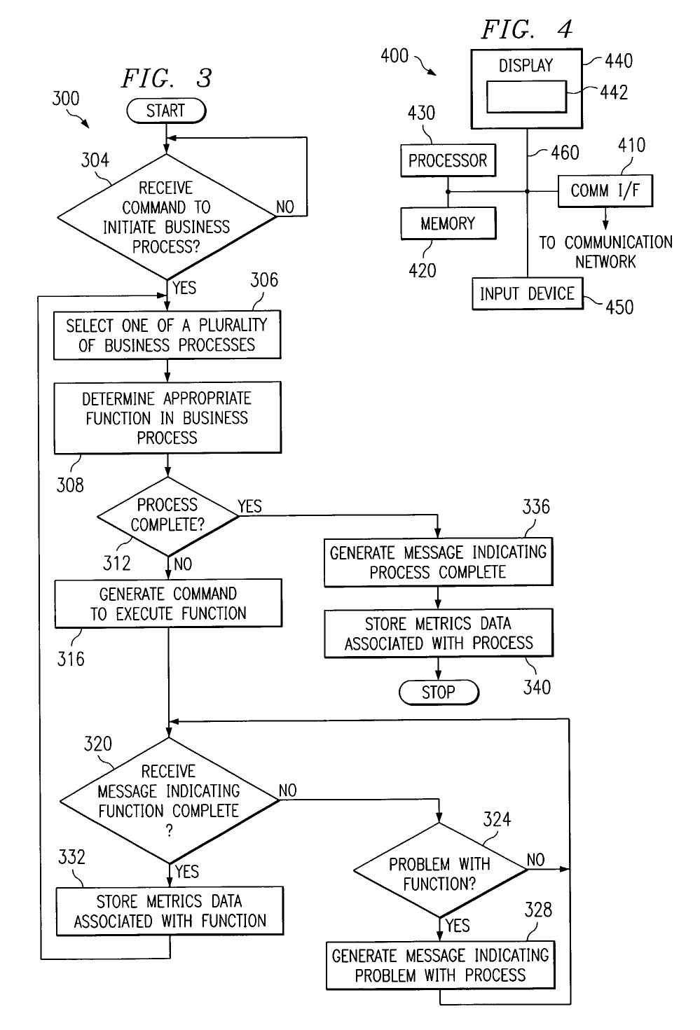

FIG. 3 is a flowchart 300 illustrating a method for implementing business processes in accordance with one embodiment of the present invention. Method 300 could be performed by business process manager 50, for example. The method begins with waiting for a command to initiate a business process at decision block 304. When such a command is received, the method continues with selecting one of a plurality of business processes at function block 306 and determining an appropriate function in the selected business process at function block 308. The selection may be made, for example, by comparing the business process designated by the command to a list of business processes, and the determination may be performed, for example, by examining business process logic for the selected business process.

At decision block 312, the method calls for determining whether the business process is complete. If the process is not complete, the method continues with generating a command to execute the function at function block 316. The command, for example, could be directed to a middleware layer 60 to pass appropriate data and have an appropriate business application or business applications implement the identified function.

At decision block 320, the method calls for determining whether a message indicating that the function is complete has been received. If such a message has not been received, the method calls for determining whether a problem has occurred with the function at decision block 324. This determination may be performed, for example, by determining whether an allotted period of time for the function has expired. If no problem has occurred with the function, the method calls for again checking whether a function-complete message has been received. If, however, a problem has occurred, the method calls for generating a message indicating that a problem has occurred with the process at function block 328. The message may then be sent to the appropriate user to alert them that a problem has occurred with the process. The method then returns to checking whether a function-complete message has been received.

If a message indicating that the function has been completed is received at decision block 320, the method calls for storing metrics data associated with the function at function block 332. For example, the time to accomplish the function could be stored. The method then returns to function block 308 to begin the next function in the business process.

Once all of the functions in the business process have been accomplished, the process is complete. The method then calls for generating a message indicating that the process is complete at function block 336. The message may then be sent to the user who initiated the process to alert them that the process is complete. The method also calls for storing metrics data associated with the process at function block 340. The method is then at an end.

Although flowchart 300 illustrates a method for implementing business processes in accordance with one embodiment of the present invention, other embodiments may include fewer, more, and/or a different arrangement of operations. For example, in certain embodiments, whether a problem has occurred with a function may not be checked. As another example, in some embodiments, the results of a function may be checked before proceeding to the next function. As a further example, in particular embodiments, the total time for executing the function may be tracked, and, if exceeded, an alert message may be generated. As an additional example, in some embodiments, no metric may be associated with the process as a whole, eliminating function block 340. As another example, in certain embodiments, data could be passed between business applications. As an additional example, in some embodiments, a status report may be generated in response to receiving a status request. A variety of other examples exist.

FIG. 4 illustrates a user interface unit 400 in accordance with one embodiment of the present invention. As discussed previously, a user interface unit provides a user with information regarding the status of a business process.

User interface unit 400 includes a communication interface 410, a memory 420, a processor 430, a display 440, and an input device 450, which are coupled together by a bus 460. Communication interface 410 may be a modem, a transceiver, a wireless interface, a network interface card, or any other type of device for receiving information for and/or sending information from user interface unit 400. Memory 420 is coupled to communication interface 410 and may include random access memory (RAM), read-only memory (ROM), compact-disc read-only memory (CD-ROM), registers, and/or any other type of electromagnetic or optical volatile or non-volatile information storage device. Processor 430 is coupled to memory 420 and may be a microprocessor, a biological computer, an atomic computer, or any other type of device for manipulating information in a logical manner. Display 440 is also coupled to memory 420 and may be a cathode-ray tube (CRT) display, a liquid crystal (LCD) display, a digital light projector (DLP), or any other type of device presenting information in a visual manner. Display 440 may present a user interface 442 to a user. User interface 442 may be a graphical user interface, a character-based user interface, a command-driven interface, or any other type of interface that presents information to a user. Input device 450 is additionally coupled to memory 420 and may include a keyboard, a mouse, a touchpad, a voice recognition system, and/or any other appropriate device by which a device may detect input from a user.

In operation, user interface unit 400 receives information regarding a business process from a server, such as server 40, using communication interface 410. The information may then be stored in memory 420 and, possibly after formatting by processor 430, presented in user interface 442 by display 440. The information may include a list of business processes available to the user, a status report on an initiated business process, a final report on an initiated business process, and/or any other information regarding a business process that the user is authorized to access. Additionally, user interface unit 400 may detect input regarding a business process from a user. Such input may indicate a request to display business processes available to the user, initiate a business process, determine the status of a business process, evaluate a business process, and/or perform any other function relating to a business process that the user is authorized to perform.

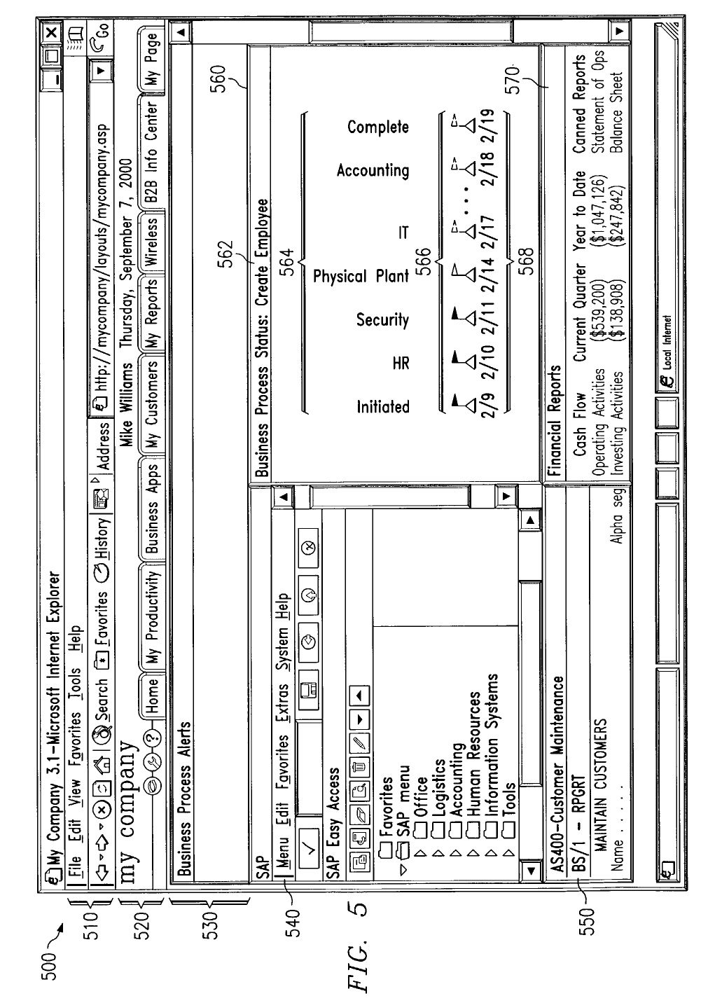

FIG. 5 illustrates a user interface 500 in accordance with the present invention. As illustrated, user interface 500 is a “dashboard-like” tool for managing business processes and is implemented as a web browser. User interface 500 may provide real-time information for allowing real-time management and reallocation of enterprise resources. As illustrated, user interface 500 contains a toolbar section 510, a user function section 520, a message alert section 530, an enterprise resource management section 540, a customer database section 550, a business process status section 560, and a financial report section 570.

Toolbar section 510 provides common web browser functions for a user, such as, for example, navigation through web pages, returning to the default web page, and allowing entry of web addresses. In general, toolbar section 510 may provide any type of functions associated with the Internet.

User function section 520 provides a list of the functions available to the user, such as, for example, viewing personal information, viewing available applications, and viewing customer-related information. In general, user function section 520 may allow a user to select from any function related to the user, a computer, or a network.

Message alert section 530 displays messages from business processes, or at least alerts the user that such messages exist. The messages could indicate that a problem has occurred with a business process, that a business process is complete, or any other appropriate message regarding a business process.

Enterprise resource management section 540 allows a user to access different functions in the enterprise. For example, if allowed, a user may access logistic, accounting, human resource, and/or information systems functions. Access to the enterprise's functions may be user dependent.

Customer database section 550 allows a user to access information on various customers of the enterprise. For example, a user may search for, organize, and view information about customers. Access to the enterprise's customer information may be user dependent.

Business process status section 560 indicates the status of a specific business process, which may be user dependent. As illustrated, business process status section 560 indicates the progress of a business process to create an employee, indicated by header 562, although the progress of any other business process could be indicated. The business process to be viewed may be selected by the user in another section of user interface 500. Business process section 560 also contains a listing 564 of the functions in the business process, status indicators 566 for the functions, and a timeline 568 for the functions. As indicated, the process was initiated on February 9, and the first two steps were completed on February 10 and February 11, respectively, with no problems, indicated by the solid flags. (If a problem occurred, the flags could have a different color, shape, or orientation; moreover, an entirely different indicator could be used.) Note that the dates of completion could be part of the metrics defined for the business process. The current function being performed of the business process, indicated by the hollow flag, is scheduled to be completed by February 14. Furthermore, the business process has a variety of functions scheduled for the future, indicated by the dashed flags. Note that the timeline may be updated based on the time at which the earlier functions are completed. Furthermore, note that more than one function may be executed at one time.

Financial report section 570 displays financial data for a business process or project. The financial data to be view may be selected by the user. Access to the enterprise's financial data may be user dependent.

User interface 500 allows a user to not only view business processes and information, but also to manage them. Moreover, managers may be able to view all of the data they need from one screen. User interface 500 may be used for internal and/or external users. For example, business partners may be invited to use an enterprise's applications across the Internet to check inventory, order parts, and/or locate components. In particular embodiments, user interface 500 may use and/or require an applet to be able to view and manage the business processes and information.

Although user interface 500 illustrates a user interface in accordance with one embodiment of the present invention, other embodiments may include less, more, and/or a different arrangement of information. For example, in certain embodiments, a user interface could include streaming data, such as weather reports, stock reports, news, or any other appropriate information. As another example, in particular embodiments, a user interface could have configurable sections, allowing the user to adjust the size of information and/or place it appears in the user interface. As a further example, business process status section 560 may convey any status information about a process, such as problems encountered, metric measurements, corrective actions, the logic of the process, or the personnel to which a function was assigned. In general, therefore, a user interface in accordance with the present invention may present any of a variety of information in any of a variety of arrangements and in any of a variety of configurations.

In accordance with the present invention, a combination of software tools and a solid technology infrastructure can be used to support the business processes of an entire enterprise. Critical business processes may be managed from a user interface unit in real-time. In other words, orders for products, inventories, and money may be monitored and managed from a console that can be used to view an entire enterprise. Managers can view the data they need via one screen and from one application.

In summary, and in accordance with one example embodiment of the present invention, automation of an enterprise's business processes may include the creation of repeatable business processes and their use across the enterprise(s) involved, automation of the business processes using software, providing remote access to the business processes, evaluation the effects of the business processes using metrics, and the use of suitable change control techniques in order to match the business processes to changing business requirements.

Although several embodiments of the method and system of the present invention have been illustrated in the accompanying drawings and described in the foregoing written description, it will be understood that the invention is not limited to the embodiments disclosed, but is capable of numerous rearrangements, modifications, and substitutions without departing from the spirit of the invention as set forth and defined by the following claims.

What is claimed is:

1. A system for automating business processes, comprising:
a plurality of business applications implementing business functions;
a middleware layer coupled to the business applications, the middleware layer facilitating the passage of data between the business applications; and
a business process manager coupled to the middleware layer, the business process manager operable to implement a business process that uses at least two of the business applications.

2. The system of claim 1, further comprising:
a server coupled to the business process manager, the server operable to retrieve and send information regarding a business process; and
a user interface unit coupled to the server, the user interface unit operable to receive the business process information from the server and present it to a user.

3. The system of claim 2, wherein the server comprises a portal web server.

4. The system of claim 2, wherein the user interface unit comprises a workstation.

5. The system of claim 1, wherein the business process manager includes logic that describes a business process, and the business process manager is operable to associate the business process logic with data from the business applications.

6. The system of claim 5, wherein the data is in Extensible Markup Language format.

7. The system of claim 1, wherein the business process manager comprises a plurality of applet servers for implementing business processes.

8. The system of claim 1, further comprising:
a second plurality of business applications implementing business functions; and
a second middleware layer coupled to the second business applications, the second middleware layer facilitating the passage of data between the second business applications;
wherein the business process manager is also coupled to the second middleware layer and is operable to implement a business process that uses at least one of the first business applications and at least one of the second business applications.

9. A method for automating business processes, comprising:
determining an appropriate function in a business process;
generating a command to execute the function;
receiving a message indicating that the function is complete;
determining another appropriate function in the business process; and
generating a command to execute the second function.

10. The method of claim 9, further comprising:
receiving a command to initiate a business process; and
selecting one of a plurality of business processes to initiate.

11. The method of claim 9, further comprising passing data between a first business application and a second business application.

12. The method of claim 11, wherein passing data between a first business application and a second business application comprises associating business process logic with business application data.

13. The method of claim 9, further comprising:
determining whether a problem has occurred with a function; and
generating, if a problem has occurred with a function, a message indicating that a problem has occurred with the business process.

14. The method of claim 13, wherein determining whether a problem has occurred with a function comprises determining whether a function has exceeded a predetermined period of time.

15. The method of claim 9, further comprising:
receiving a request to view the status of the business process; and
generating a status report of the business process.

16. The method of claim 9, wherein generating a command to execute the function comprises generating a command for a business application to execute the function.

17. A system for automating business processes, comprising:
means for determining an appropriate function in a business process;
means for generating a command to execute the function;
means for receiving a message indicating that the function is complete;
means for determining another appropriate function in the business process; and
means for generating a command to execute the second function.

18. The system of claim 17, further comprising means for passing data between a first business application and a second business application.

19. The system of claim 18, wherein passing data between a first business application and a second business application comprises associating business process logic with business application data.

20. The system of claim 17, further comprising:
means for determining whether a problem has occurred with a function; and
means for generating, if a problem has occurred with a function, a message indicating that a problem has occurred with the business process.

21. A method for automating business processes, comprising:
defining a business process to be automated;
increasing repeatability of the defined process;
increasing predictability of the defined process;
automating the business process; and
refining the business process.

22. The method of claim 21, wherein defining a business process to be automated comprises identifying a plurality of functions to be accomplished by the business process.

23. The method of claim 22, wherein at least some of the functions are performed by business applications.

24. The method of claim 21, wherein increasing repeatability of the defined process comprises documenting the process.

25. The method of claim 21, wherein increasing predictability of the defined process comprises establishing metrics for the process.

26. The method of claim 21, wherein automating the business process comprises determining a logical sequence in which business functions are to be performed.

27. The method of claim 21, wherein refining the business process comprises using a change control procedure to match the business processes with the changed business requirement.

28. A system for automating business processes, comprising:
a user interface, comprising:
a message alert section operable to alert a user of a message received from a business process; and
a business process status section operable to display the status of a business process.

29. The system of claim 28, wherein the user interface is operable to display a list of business processes available to a user.

30. The system of claim 28, wherein the user interface is operable to receive input from a user regarding the selection of a business process to be initiated.

31. The system of claim 28, wherein the business process status section displays a timeline of the business process.

32. The system of claim 31, wherein the timeline indicates the status of the functions of the business process.

33. The system of claim 28, wherein the message indicates that a problem has occurred with the business process.

34. The system of claim 28, wherein the message alert section is further operable to display the message.

35. A method for automating business processes, comprising:
receiving a message from a business process;
generating a user alert that a message from a business process has been received;
receiving a request to display the status of a business process; and
displaying the status of the business process.

36. The method of claim 35, further comprising displaying a list of business processes available to a user.

37. The method of claim 35, further comprising receiving input from a user regarding the selection of a business process to be initiated.

38. The method of claim 35, wherein displaying the status of the business process comprises displaying a timeline of the business process.

39. The method of claim 38, wherein the timeline indicates the status of the functions of the business process.

40. The method of claim 35, wherein the message indicates that a problem has occurred with the business process.

41. The method of claim 35, further comprising displaying the message.

42. A system for automating business processes, comprising:
a plurality of business applications implementing business functions;
a middleware layer coupled to the business applications, the middleware layer facilitating the passage of Extensible Markup Language data between the business applications;
a second plurality of business applications implementing business functions;
a second middleware layer coupled to the second business applications, the second middleware layer facilitating the passage of Extensible Markup Language data between the second business applications;
a business process manager coupled to the middleware layers, the business process manager comprising a plurality of applet servers to implement business processes, at least one of the business processes using at least one of the first business applications and at least one of the second business applications, wherein the business process manager includes logic that describes a business process, and the business process manager is operable to associate the business process logic with data from the business applications;
a portal web server coupled to the business process manager, the server operable to retrieve and send information regarding a business process; and
a user interface unit coupled to the server, the user interface unit operable to receive the business process information from the server and present it to a user.
